(19) United States
(12) Patent Application Publication
(10) Pub. No.: US 2007/0180755 A1
(43) Pub. Date: Aug. 9, 2007

(54) Decoy apparatus

(75) Inventors: Scott Neeley, Ogden, UT (US); Garrett Woolsey, Ogden, UT (US)

Correspondence Address: VAN COTT, BAGLEY, CORNWALL & MCCARTHY, P.O. BOX 45340, SALT LAKE CITY, UT, 84145-0340, US

(73) Assignee: Team Goose Spot, LLC

(21) Appl. No.: 11/496,739

(22) Filed: Jul. 31, 2006

Related U.S. Application Data
(60) Provisional application No. 60/771,333, filed on Feb. 8, 2006.

(51) Int. Cl. A01M 31/06

(52) U.S. Cl. 43/3; 43/2

(57) ABSTRACT

An apparatus for imparting motion to a decoy such as, for example, a bird decoy is disclosed and includes a frame positionable on the ground, a pivot-post secured to the frame and a plate pivotally connected to the pivot-post. First and second plate-support members are positioned adjacent the pivot-post, and constrain the plate to move in fore and aft tilting and pivoting directions, allowing the decoy to move in a three-dimensional like manner. A rotary drive mechanism is eccentrically coupled to a pin-member extending from the plate and serves to drive the plate and, hence, the decoy in the tilting and pivoting manner of movement.

### RELATED APPLICATIONS

This present application claims priority to U.S. Provisional Patent Application No. 60/771,333, entitled “Decoy Apparatus,” filed Feb. 8, 2006.

### TECHNICAL FIELD OF THE INVENTION

The present invention relates to decoys and, more specifically, to movable bird or animal decoys, such as geese, duck, turkey, rabbit or varmint decoys.

### BACKGROUND OF THE INVENTION

Decoys have been used to lure animals or birds, such as, for example, turkeys or various varmints, into sufficient range for hunting, observation and study or photography. The goal of decoy design is to provide a life-like appearance that attracts real animals or birds. Prior art designs have included, for example, both stationary decoys and decoys that exhibit movement in one or more degrees of freedom. In this regard, the goal is to incorporate the most life-like movement into the decoy in as simple a fashion as possible. The apparatus of the present invention addresses this goal by achieving a life-like three-dimensional movement of an otherwise stationary decoy through a novel linkage mechanism between a single rotary output shaft and a plate—upon which the decoy is mounted—that is constrained to tilt in the fore and aft direction and pivot about an imaginary axis fixed with respect to the plate.

### SUMMARY OF THE INVENTION

An apparatus for imparting motion to a decoy such as, for example, a bird or varmint decoy is disclosed and includes a frame positionable on the ground, a pivot-post secured to the frame and a plate pivotally connected to the pivot-post. First and second plate-support members are positioned adjacent the pivot-post, and constrain the plate to move in fore and aft tilting and pivoting directions, allowing the decoy to move in a three-dimensional like manner. A rotary drive mechanism is eccentrically coupled to a pin-member extending from the plate and serves to drive the plate and, hence, the decoy in the tilting and pivoting manner of movement.

### BRIEF DESCRIPTION OF THE DRAWINGS

FIG. 1 illustrates a side view of the decoy apparatus of the present invention having a bird decoy mounted on the plate;

FIG. 2 illustrates an overhead view of the decoy apparatus of the present invention with the bird decoy removed from the plate;

FIG. 3 illustrates an upward perspective view of the undercarriage of the decoy apparatus of the present invention;

FIG. 4 illustrates a downward perspective view of the decoy apparatus of the present invention with the plate in a forward leaning orientation; and

FIG. 5 illustrates a downward perspective view of the decoy apparatus of the present invention with the plate in a rearward leaning orientation.

### DETAILED DESCRIPTION OF THE INVENTION

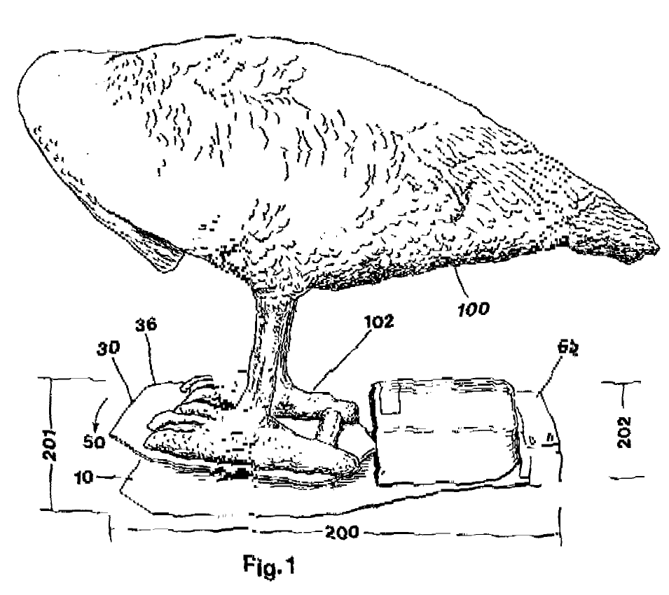

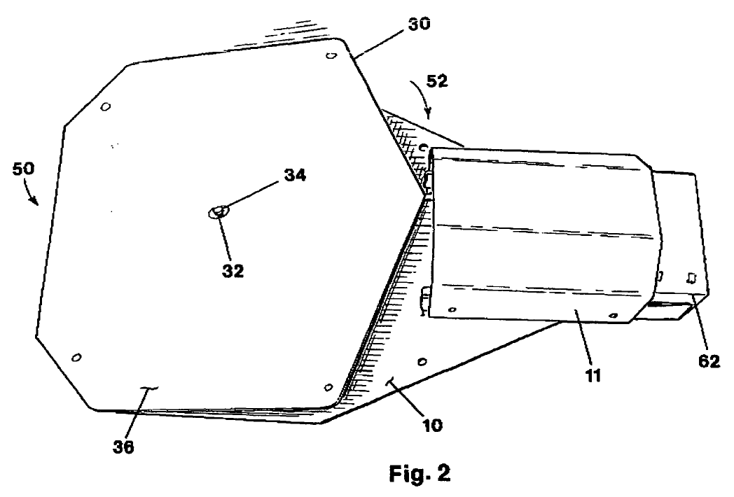

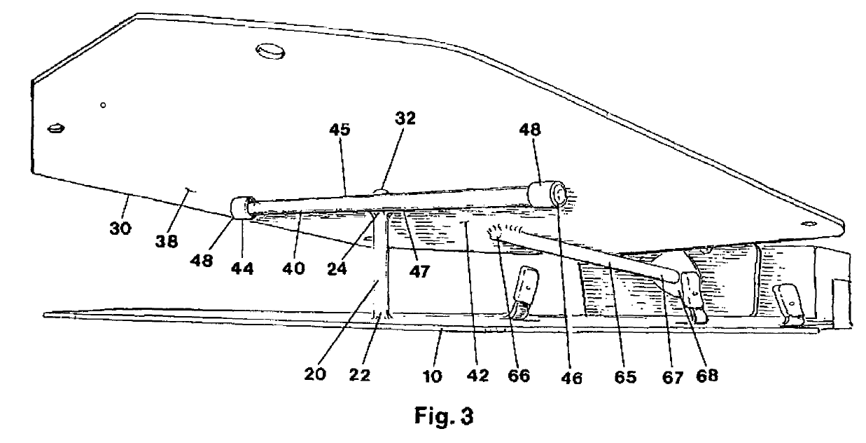

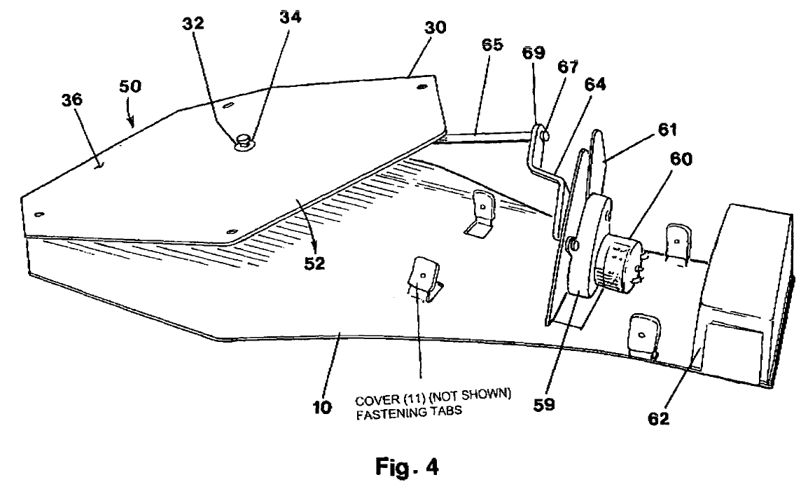

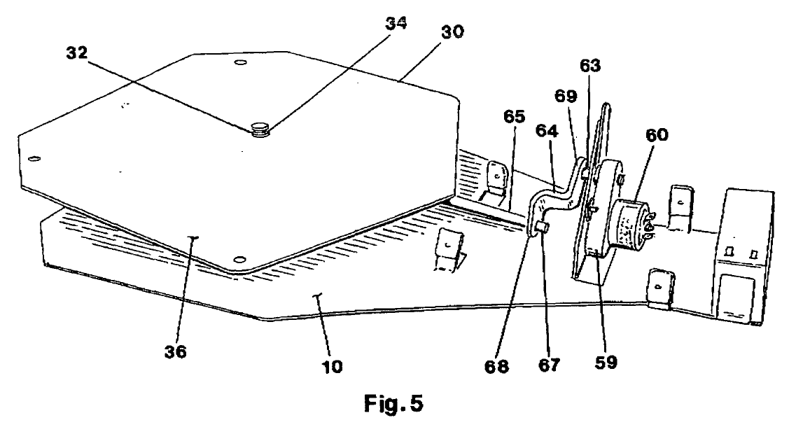

Generally, the present invention relates to an apparatus for decoys and, specifically, to an apparatus for bird or varmint decoys. In one embodiment, which is described and illustrated through reference to FIGS. 1 through 5, the apparatus includes a frame 10 that is positionable on the ground. A pivot-post 20 extends upwardly from the frame 10, and has a first end 22 secured to the frame 10 and a second end 24 extending away from the frame 10. A plate 30 is pivotally mounted to the second end 24 of the pivot-post 20. The plate 30 includes a hole 32 positioned near its center that is sized for receiving the second end 24 of the pivot-post 20. A snap-clip 34 fastens to the second end 24 of the pivot-post 20 to maintain the plate 30 pivotally secured to the pivot-post 20.

The plate 30 includes an upper surface 36 and a lower surface 38. First and second plate support members 40, 42 are positioned adjacent the lower surface 38 of the plate 30. The first plate support member 40 includes a first end 44 in sliding contact with the lower surface 38 of the plate 30 and a second end 45 secured to the pivot-post 20. In similar fashion, the second plate support member 42 includes a first end 46 in sliding contact with the lower surface 38 of the plate 30 and a second end 47 secured to the pivot-post 20. Wear surface members 48—e.g., rubber or plastic sections of tubing—are positioned over the first ends 44, 46 of the first and second plate support members 40, 42 to reduce wear or friction against the lower surface 38 of the plate 30.

In one embodiment, the first and second plate support members 40, 42 are positioned substantially collinear with the hole 32 that receives the second end 24 of the pivot-post 20. When positioned against the lower surface 38 of the plate in this manner, the first ends 44, 46 of the first and second plate support members 40, 42 constrain the plate 30 to tilt in the fore and aft directions 50, 52 substantially about an imaginary line connecting the first ends 44, 46. The plate 30 is further constrained to pivot about the second end 24 of the pivot-post 20. These two degrees of freedom for movement of the plate 30—i.e., tilting the plate 30 fore and aft 50, 52 about the first ends 44, 46 of the first and second plate support members 40, 42 and pivoting the plate 30 about the second end 24 of the pivot-post 30—enable quasi three-dimensional like movement of a decoy 100 positioned on the plate 30 that attracts wild game to the vicinity of the decoy.

Movement of the plate 30 is driven by a drive mechanism such as, for example, an electric motor 60. In one embodiment, the electric motor 60 is secured to a flange 61 that is itself secured to the frame 10. The electric motor 60 is connected to and powered by a battery 62 that is removably positioned atop the frame 10. The electric motor 60 drives a reduction mechanism 59 that reduces the speed of the electric motor output shaft to a speed suitable for driving the plate 30. The reduction mechanism 59 (which, depending on the type of motor, may be integral with the motor itself) drives a rotary output shaft 63. The rotary output shaft 63 is fixedly connected to an eccentric link member 64 that serves ultimately to drive the plate 30 in the tilting and pivoting motions described above.

More specifically, the eccentric link member 64 has a first end 68 and a second end 69. The first end 68 is fixedly connected to the rotary output shaft 63 of the reduction mechanism 59 or electric motor 60. A pin-member 65 is positioned between the plate 30 and the eccentric link member 64. The pin-member 65 has a first end 66 that is secured or fixedly connected to the plate 30 and a second end 67 that is freely positioned through a hole drilled through the second end 69 of the eccentric link member 64. Freely positioning the second end 67 of the pin member 65 in the hole of the eccentric link member 64 permits the eccentric link member 64 to rotate with the rotary output shaft 63 and, at the same time, drive the plate 30 in the tilting and pivoting motions described above.

The decoy 100 is mounted to the plate 30 using any of several means. For example, the decoy 100 includes a pair of legs and feet 102. The legs and feet 102 may be secured to the plate using bolts extending from the bottom of the feet and through the plate 30, with the bolts being secured to the lower surface 38 of the plate 30 using nuts secured to the bolts. The feet may also be secured to the plate 30 using adhesive materials or strips of Velcro. Many decoys are also supplied with a stake extending from the underbelly and designed to penetrate the ground. For such decoys, a correspondingly sized and shaped female receptacle may be secured to the upper surface 36 of the plate 30 for receiving the stake. Other modes and manners of securing the decoy to the upper surface 36 of the plate 30 will be readily recognized by those having skill in the art.

In one embodiment, the apparatus of the present invention drives a turkey decoy 100 in the tilting and pivoting movement above described. The frame 10 is about eighteen to about twenty-four inches in overall length 200, about twelve inches in width 201 near the region of the plate 30 and about four inches in width 202 near the region of the motor 60 and battery 62. The plate 30 is approximately about twelve inches square. Although the plate 30 is illustrated as being roughly pentagonal (with the two fore-most corners removed), the plate 30 may be circular, rectangular, square or of other geometric shapes of similar size. The motor 60 is a twelve-volt direct current motor available from local hobby shops. A twelve-volt battery, also available from local hobby shops, is used to drive the motor 60. The rotational speed of the rotary output shaft 63 is approximately twenty rpm. The axis of the rotary output shaft 63 is located approximately two inches above the frame 10 and the radial length of the eccentric link member—i.e., the projected radial length from the axis of the rotary output shaft 63 to the center of the receiving hole positioned at the second end 69 of the eccentric link member 64—is approximately one and one-half inches. The first and second plate support members 40, 42 are vertically positioned approximately two inches from the frame 10, and horizontally positioned approximately three inches from the pivot-post 20. The pin-member 65 is approximately two and one-half inches in length from the boundary of the plate 30, and its second end 67 makes operable contact with the second end 69 of the eccentric link member 64 approximately eight inches from the second end 24 of the pivot-post 20. All components of the apparatus are constructed using light weight steel and all fixed connections between components are made using welds. For safety and noise reduction, a cover 11 is removably secured to the frame 30, and covers the motor 60 and all moving components of the drive system.

While certain embodiments and details have been included herein and in the attached invention disclosure for purposes of illustrating the invention, it will be apparent to those skilled in the art that various changes in the methods and apparatuses disclosed herein may be made without departing form the scope of the invention, which is defined in the appended claims.

What is claimed is:

1. An apparatus for imparting motion to a bird decoy, comprising:
a frame positionable on the ground;
a pivot-post having a first end secured to the frame and a second end extending away from the frame;
a plate pivotally connected to the pivot-post;
a first plate-support member having a first end in sliding contact with the plate;
a second plate-support member having a first end in sliding contact with the plate;
a pin-member having a first end secured to the plate and a second end;
a drive mechanism having a rotatable output shaft;
an eccentric link member having a first end fixedly connected to the shaft and a second end freely connected to the second end of the pin-member.

2. The apparatus of claim 1, wherein the plate includes a hole sized to receive the second end of the pivot-post.

3. The apparatus of claim 1, wherein the first plate-support member has a second end secured to the pivot-post.

4. The apparatus of claim 1, wherein the first plate-support member has a second end secured to the frame.

5. The apparatus of claim 1, wherein the first plate-support member has a wear-surface positioned on the first end.

6. The apparatus of claim 1, wherein the plate has an upper surface and a lower surface, and wherein the first end of the pin-member is secured to the lower surface of the plate.

7. The apparatus of claim 1, wherein the drive mechanism is an electric motor, and wherein the electric motor is secured to the frame.

8. The apparatus of claim 1, wherein the second end of the eccentric link-member includes a hole sized to receive the second end of the pin-member.

9. The apparatus of claim 1, wherein the drive mechanism includes an electric motor and a speed reduction mechanism operably coupled between the electric motor and the rotatable output shaft.

10. The apparatus of claim 7, further comprising a battery connected to the electric motor through wires.

11. The apparatus of claim 1, wherein a turkey decoy is mounted to the plate.

12. An apparatus for imparting motion to a decoy, comprising:
a pivot-post having a first end and a second end extending away from the first end;
a plate pivotally connected to the second end of the pivot-post;
a first plate-support member having a first end in sliding contact with the plate;
a second plate-support member having a first end in sliding contact with the plate;
a pin-member having a first end secured to the plate and a second end;
a drive mechanism having a rotatable output shaft;
an eccentric link member having a first end fixedly connected to the shaft and a second end freely connected to the second end of the pin-member.

13. The apparatus of claim 12, wherein the first end of the pivot-post is configured for insertion into the ground.

14. The apparatus of claim 12, wherein the first plate-support member is connected to the pivot-post.

15. The apparatus of claim 12, wherein the drive mechanism includes a frame and a stake-member connected to the frame, and wherein the stake-member is configured for insertion into the ground.
